(19) United States
(12) Patent Application Publication
(10) Pub. No.: US 2024/0253383 A1
(43) Pub. Date: Aug. 1, 2024

(54) Digital printing system and process

(71) Applicant: LANDA CORPORATION LTD., Rehovot (IL)

(72) Inventors: Gil Baran, Rehovot (IL); Yoav Geva, Moshav Tal Shahar (IL)

(21) Appl. No.: 18/565,549

(22) PCT Filed: Jun. 13, 2022
(86) PCT No.: PCT/IB2022/055433

§ 371 Date: Nov. 30, 2023

Related U.S. Application Data
(60) Provisional application No. 63/210,507, filed on Jun. 15, 2021.

(51) Int. Cl. B41M 5/025; B41J 2/01; B41J 2/21; B41M 3/00

(52) U.S. Cl. CPC B41M 5/025; B41J 2/2103; B41M 3/008; B41J 2002/012

(57) ABSTRACT

A printing method includes producing a first image at a first position (16a, 23a) on a movable intermediate transfer member (ITM) (44) of a printing system (10), and moving the ITM (44) for transferring the first image to a first substrate (50). For a second image that is intended to be produced on the ITM (44) at a second position (16b, 23b) different from the first position (16a, 23a): (i) a deliberate offset (18, 24) of the second position (16b, 23b) relative to the first position (16a, 23a), is specified, (ii) a movement of the ITM (44) that would at least partially compensate for the offset (18, 24) when transferring the second image to a second substrate (50), is calculated, and (iii) the second image is produced and the ITM (44) is moved in accordance with the calculated movement, for transferring the second image to the second substrate (50).

### CROSS-REFERENCE TO RELATED APPLICATIONS

This application claims the benefit of U.S. Provisional Patent Application 63/210,507, filed Jun. 15, 2021, whose disclosure is incorporated herein by reference.

### FIELD OF THE INVENTION

The present invention relates generally to digital printing, and particularly to methods and systems for reducing a signature produced on an intermediate transfer member during a printing process.

### BACKGROUND OF THE INVENTION

Some printing systems have an intermediate transfer member, which is configured to receive an image and to transfer the image to a target substrate. In some cases, a print batch that contains a large number of copies (for example, thousands) of a particular image produced on the intermediate transfer member, may cause undesired formation of a trace of the image on the intermediate transfer member, so that the image silhouette may appear in prints of another image, e.g., in the next print batch. This phenomenon is also referred to herein as “memory” or “ghost printing,” and may reduce the quality of subsequent images that are printed using the same intermediate transfer member.

### SUMMARY OF THE INVENTION

An embodiment of the present invention that is described herein provides a method for printing, the method includes producing a first image at a first position on a movable intermediate transfer member (ITM) of a printing system, and moving the ITM for transferring the first image to a first substrate, and for a second image that is intended to be produced on the ITM at a second position different from the first position: (i) a deliberate offset of the second position relative to the first position, is specified, (ii) a movement of the ITM that would at least partially compensate for the offset when transferring the second image to a second substrate, is calculated, and (iii) the second image is produced and the ITM is moved in accordance with the calculated movement, for transferring the second image to the second substrate.

In some embodiments, the first and second images are copies of a given image. In other embodiments, the second position, which is covered by the second image, partially overlaps the first position, which is covered by the first image. In yet other embodiments, the ITM includes a closed loop, which is rotated, and: (i) during a first revolution of the ITM, producing the first image by positioning the ITM at the first position relative to an image forming station, and (ii) during a second revolution of the ITM, producing the second image by positioning the ITM at the second position relative to the image forming station.

In an embodiment, the method includes, after producing the first image and before producing the second image: (i) producing on the ITM a third image at a third position, which is shifted relative to an intended position of the third image, (ii) calculating an additional movement of the ITM that would at least partially compensate for the shifting when transferring the third image to a third substrate, and (iii) moving the ITM in accordance with the calculated additional movement, for transferring the third image to the third substrate.

In some embodiments, the deliberate offset is specified at a direction parallel to a moving direction of the ITM. In other embodiments, the deliberate offset is specified at a direction that in not parallel to a moving direction of the ITM.

In some embodiments, the deliberate offset of the second position is carried out along a first direction, the method includes, for a plurality of third images intended to be produced on the ITM at a plurality of third positions, respectively, different from the first and second positions: (i) specifying additional deliberate offsets of the third positions along the first direction based on a predefined stroke size, (ii) calculating a plurality of third movements of the ITM that would at least partially compensate for the additional deliberate offsets when transferring the third images to third substrates, respectively, and (iii) producing the third images and moving the ITM in accordance with the calculated movement, for transferring the third images to the third substrates, respectively.

In other embodiments, the first, second and third substrates have a given size at least along the first direction, and at least the predefined stroke size depends on the given size. In yet other embodiments, the method includes, after applying the deliberate offset and the additional deliberate offsets and producing and transferring the first, second and third images in accordance with the predefined stroke size, performing the deliberate offset and the additional deliberate offsets at a second direction, different from the first direction.

There is additionally provided, in accordance with an embodiment of the present invention, a system including a printing assembly and a processor. The printing assembly is configured to: (i) produce a first image at a first position on a movable intermediate transfer member (ITM) of a printing system, and to move the ITM for transferring the first image to a first substrate, and (ii) produce a second image at a second position, different from the first position, and to move the ITM for transferring the second image to a second substrate. The processor is configured to: (i) specify a deliberate offset of the second position relative to the first position, (ii) calculate a movement of the ITM that would at least partially compensate for the offset when transferring the second image to the second substrate, and (iii) control the printing assembly to move the ITM in accordance with the calculated movement, for transferring the second image to the second substrate.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIGS. 2A, 2B, 2C and 2D are schematic pictorial illustrations of appearances of a memory effect on an intermediate transfer member (ITM) of a digital printing system, in accordance with embodiments of the present invention;

FIG. 3 is a schematic side view of an apparatus for compensating an offset in a position of an image produced on the ITM when transferring an image to a target substrate, in accordance with an embodiment of the present invention; and

FIG. 4 is a flow chart that schematically illustrates a method for reducing a memory effect in a digital printing system having an ITM, in accordance with an embodiment of the present invention.

### DETAILED DESCRIPTION OF EMBODIMENTS

### Overview

Some printing systems have an intermediate transfer member, which is configured to receive an image and to transfer the image to a target substrate. In some cases, a print batch that contains a large number of copies (for example, thousands) of a particular image produced on the intermediate transfer member, may cause an undesired formation of a trace of the image on the intermediate transfer member, so that the image silhouette may appear in prints of another image, e.g., in the next print batch. This phenomenon is also referred to herein as “memory” or “ghost printing,” and may reduce the quality of subsequent images that are printed using the same intermediate transfer member.

In principle, it is possible to reduce the appearance of the memory in subsequent prints by often replacing and/or extensive cleaning processes of the intermediate transfer member. Such operations, however, reduce the utilization and productivity of the printing system, and also result in a large amount of chemicals and intermediate transfer members turned into waste. Embodiments of the present invention that are described hereinafter provide efficient methods and systems for reducing the appearance of memory in digital printing processes using an intermediate transfer member.

In some embodiments, a digital printing system comprises a printing assembly having: (i) an image forming station configured to apply droplets of printing fluids (e.g., jetting ink droplets) to a surface of an intermediate transfer member (ITM) for producing an image thereon, (ii) an impression station, configured to transfer the image from the ITM to a target substrate (e.g., a sheet), and (iii) an ITM module configured to move the ITM for (a) producing the image by receiving the ink droplets from the image forming station, and (b) transferring the image to the sheet. The digital printing system further comprises, a processor, which is configured to control the printing assembly.

In the present example, the ITM comprises a flexible member formed in an endless loop and having (a) multiple panels, each panel intended to receive an image, and (b) one or more sections that are not intended to receive an image. The ITM module is configured to rotate the ITM in multiple revolutions, and for each panel and each revolution, the processor controls the printing assembly to produce the image, and subsequently to transfer the image to the sheet, so that in the next revolution, the given panel is ready to receive the next image.

In some embodiments, for a given panel among the panels the processor is configured to control the printing assembly to: (i) produce, during a first revolution, a first image at a first position on the ITM, and to move the ITM for transferring the first image to a first sheet, and (ii) produce on the given panel, during a second subsequent revolution, a second image at a second position, different from the first position, and to move the ITM for transferring the second image to a second sheet.

In some embodiments, the processor is configured to: (i) specify a deliberate offset of the second position relative to the first position, (ii) calculate the movement of the ITM that would compensate for the offset when transferring the second image to the second substrate, and (iii) control the printing assembly to move the ITM in accordance with the calculated movement, for transferring the second image to the second substrate. Note that the undesired memory signature on the ITM is reduced by altering the position of the image produced on a given panel during different revolutions of the ITM.

In some embodiments, in addition to applying the offset to each panel between subsequent revolutions of the ITM, the processor is configured to apply the same technique for shifting the relative position of the images between different panels of the ITM. For example, in an ITM having eleven (11) panels, the processor may apply the technique described above to each pair of images produced on a respective pair of adjacent panels. In each pair, the images are referred to herein as “earlier” and “subsequent” images, which are produced on “earlier” and “subsequent” panels, respectively. In this example embodiment, the processor controls the printing assembly to shift the position of the subsequent image, relative to the position of the earlier image, by an offset of about 60 μm. Thus, in the aforementioned given panel, the second image produced in the second revolution is positioned at an offset of about 660 μm (i.e., 11 shifts of about 60 μm) relative to the position of the first image produced in the first revolution.

The disclosed techniques improve: (i) the quality of images printed in a digital printing system having an intermediate transfer member, (ii) the productivity of such systems, and (iii) the impact of such printing processes on the cleanliness of the environment.

### SYSTEM DESCRIPTION

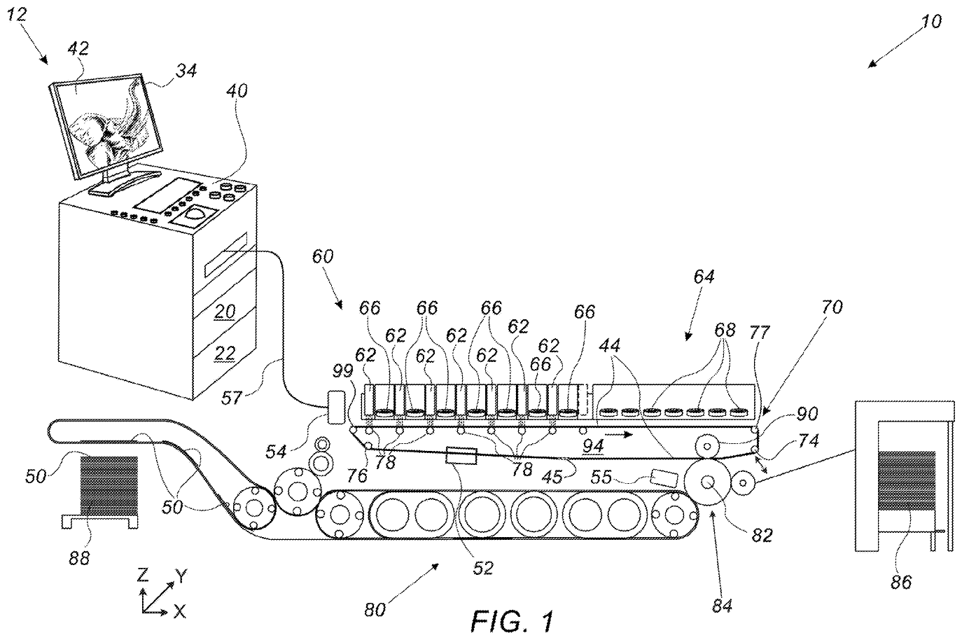

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate transfer member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black, and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” “color to color position difference,” “bar to bar registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 is guided over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

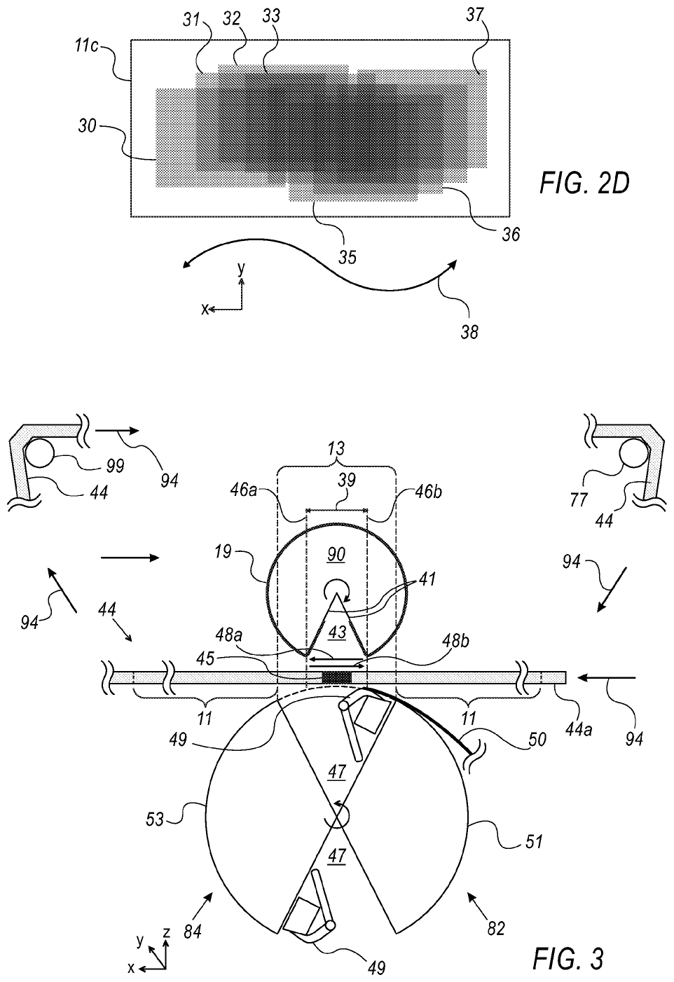

In impression station 84, blanket 44 passes between an impression cylinder 82 and a pressure cylinder 90, which is configured to carry a compressible blanket (shown in FIG. 3 below). In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic, or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52.

Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single- and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of threshold(s), and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Reducing the Appearance of Memory Effect on Blanket

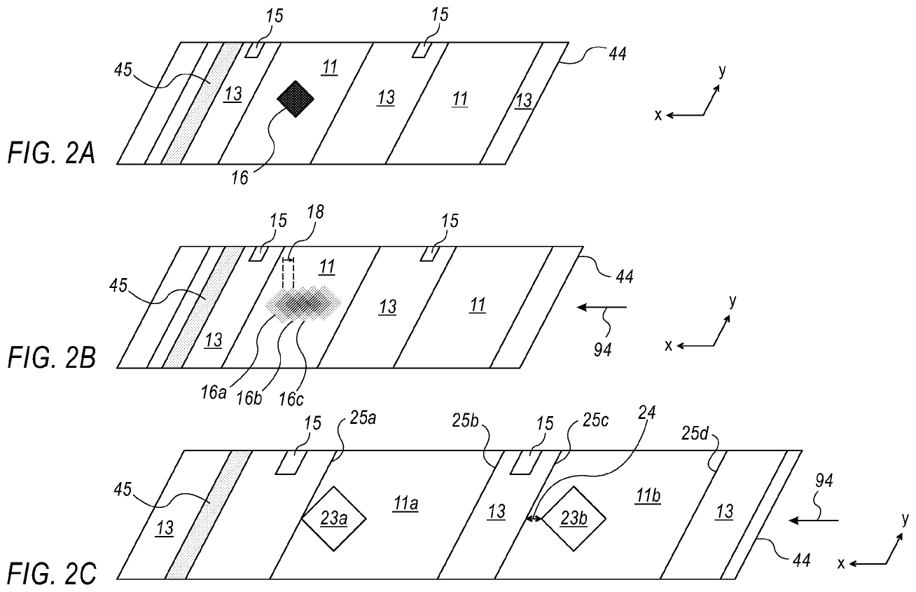

FIG. 2A is a schematic pictorial illustration of an appearance of a memory effect on blanket 44 of system 10, in accordance with an embodiment of the present invention.

In some embodiments, blanket 44 comprises multiple panels 11, each panel 11 is intended to receive an image as described in detail in FIG. 1 above. Blanket 44 further comprises one or more sections 13, which are not intended to receive the images, and may have various types of patterns used for assisting the printing process described in FIG. 1 above. Note that panels 11 are also sections of blanket 44 (intended to receive the images), but are referred to herein as “panels” in order to differentiate them over “sections 13” that are not intended to receive the images.

In the present example, each section 13 comprises, at a predefined position, a marker 15 that may serve as a reference position for controlling the movement of blanket 44 relative to the stations and assemblies of system 10 described in FIG. 1 above. Moreover, seam 45, which is not intended to receive droplets of ink, is positioned in one of sections 13. Note that in FIG. 2A, the size of panel 11 and section 13 along X-axis of blanket 44 are not in scale. In the present example, the ratio between the sizes of panel 11 and section 13, along X-axis, may be about eight (e.g., panel 11 has a length of about 940 mm, whereas section 13 has a length of about 190 mm), or any other suitable ratio, for example, between 5 and 20.

In the context of the present disclosure and in the claims, the terms “about” or “approximately” for any numerical values or ranges indicate a suitable dimensional tolerance that allows the part or collection of components to function for its intended purpose as described herein.

In some cases, a print job, also referred to herein as a print batch, which contains a large number (e.g., thousands or more) of copies of a particular image produced on blanket 44, may undesirably cause the formation of a trace of the image on blanket 44. Having the trace formed on the surface of blanket 44 may result in a silhouette of the image that may appear in subsequent prints of another image, e.g., in the next print batch. This undesired phenomenon is also referred to herein as “a memory effect” or “memory” or “ghost printing” that may appear on each panel 11, and is shown in the example of FIG. 2A, as a memory 16. In such cases, a silhouette of memory 16 may be printed on sheets 50 in a subsequent batch (e.g., printing job) of a subsequent image, and therefore, may reduce the quality of the subsequent images that are printed using the same piece of blanket 44. Note that memory 16 typically appears in every panel 11 of blanket 44, but for the sake of presentation and conceptual clarity, memory 16 appears in FIG. 2A only on one panel 11.

The magnitude of the memory effect and appearance may be affected by various factors, such as but not limited to: the number of blanket revolutions (described in FIG. 2B below) and number of copies of the image in the printing job, the ink type (e.g., formulation), colors and blanket temperature, the coverage level of different ink colors in the image (e.g., an image having a coverage of 60% K, 60% C, 60% M and 60% Y will typically have a larger memory effect compared to an image having a coverage of 40% C, 27% M and 27% Y), blanket treatment process, temperature and chemicals used in blanket treatment station 52, the magnitude of various types of registration errors occurring in the printing process, the uniformity of the image formed on blanket 44, the service time and aging of blanket 44, the type of target substrate (e.g., uncoated sheets 50, coated sheets 50 or layer structure of continuous web), and other system-related and process-related parameters. For example, when comparing the memory effect between two systems 10, the system having better image uniformity and lower registration error is expected to have a larger memory effect.

FIG. 2B is a schematic pictorial illustration of an appearance of the memory effect on blanket 44 when applying a deliberate offset to each copy of the image produced during each respective revolution of blanket 44, in accordance with an embodiment of the present invention.

For the sake of the description of the following embodiments, system 10 comprises a printing assembly, which incorporates image forming station 60 impression station 84, and blanket module 70. In the present example, the printing assembly is controlled by processor 20. As described in FIG. 1 above, blanket 44 comprises a flexible member formed in an endless loop. Moreover, as described in FIG. 2A above, the memory traces typically appear in every panel 11 of blanket 44, but for the sake of presentation and conceptual clarity, the traces of the memories described herein appears in FIG. 2B only on one panel 11, also referred to in FIG. 2B as “a given panel 11.”

In some embodiments, blanket module 70 is configured to rotate blanket 70 in multiple revolutions, and for each panel 11 and each revolution, processor 20 controls the printing assembly to produce a copy of the image, and subsequently, to transfer the image from panel 11 to sheet 50. Subsequently, blanket 44 undergoes various processes in blanket treatment station 52, so that in the next revolution, the same panel 11 is ready to receive from image forming station 60 the ink droplets for producing the next copy of the image.

In the example of given panel 11 of blanket 44, processor 20 is configured to control the printing assembly to produce, during a first revolution, a first image at a first position on blanket 44, and subsequently, to move blanket 44 in moving direction 94 for transferring the first image to a first sheet 50 (received from input stack 86 as shown in FIG. 1 above). As shown in FIG. 2B, after transferring the first image to first sheet 50, an undesired signature or trace of a memory 16a remains on blanket 44.

In some embodiments, during a second subsequent revolution of blanket 44, processor 20 is configured to control the printing assembly to produce on given panel 11, a second image at a second position, which is different from the first position of the first image described above. Subsequently, processor 20 controls the printing assembly to move blanket 44 in moving direction 94 for transferring the second image to a subsequent second sheet 50, also received from input stack 86 as shown in FIG. 1 above.

In the example of FIG. 2B, after transferring the second image to second sheet 50, an undesired trace of a memory 16b remains on blanket 44. As shown in FIG. 2B, processor 20 controls the printing assembly to apply the same technique in subsequent revolutions of blanket 44, each revolution undesirably produces on blanket 44 an additional memory 16, such as memory 16c produced in the third revolution.

In some embodiments, processor 20 is configured to specify a deliberate offset 18 of the second position relative to the first position. In the example of FIG. 2B, the deliberate offset is shown between memories 16a and 16b corresponding to the positions of the first and second images, respectively.

In some embodiments, the position of memory 16b at least partially overlaps the position of memory 16a, as shown in the example of FIG. 2B. In other embodiments, however, processor 20 may set offset 18 sufficiently large, such that the signatures of memories 16a and 16b may appear disconnected from one another. Note that the appearance of the memory is determined by the amount of overlap between the images produced on the surface of given panel 11 during the respective revolutions of blanket 44. As shown in FIG. 2A, the magnitude of memory 16 is substantially larger compared to that of memories 16a-16c of FIG. 2B.

In some embodiments, processor 20 is configured to implement offset 18 by controlling image forming station 60 to apply (e.g., jet) the ink droplets to the surface of panel 11 at a predefined delay relative to the originally intended jetting time. In such embodiments, when blanket is moved in direction 94, delaying the jetting results in having the signature memory 16b to appear at the right side of memory 16a, as shown in FIG. 2B. Similarly, processor 20 may control image forming station to advance the jetting of the ink droplets. In other words, to jet the ink droplets earlier than the originally intended jetting time, so that the signature of memory 16b may appear at the left side of memory 16a (opposite to the position of memory 16b relative to memory 16a, as shown in FIG. 2B).

In the context of the present disclosure, the term “originally intended” refers to the specified jetting time of the ink droplets without offsetting the position of a given image produced on a respective panel 11.

In some embodiments, processor 20 is configured to calculate the movement of blanket 44 that would, at least partially and typically fully, compensate for the offset when transferring the second image to second sheet 50. One implementation of such embodiments is described in detail in FIG. 3 below. Processor 20 is configured to control the printing assembly to move blanket 44 in accordance with the calculated movement, for transferring the second image to second sheet 50 without causing an image-to-substrate registration error.

In some embodiments, processor 20 may use marker 15 for controlling the position of each image produced on each panel 11 during every revolution of blanket 44. In other embodiments, processor 20 may use any other reference position on blanket 44, e.g., a position of one or more fibers of blanket 44, for controlling the position of each image produced on each panel 11 during every revolution of blanket 44.

In the example of FIG. 2B, processor 20 controls the printing assembly to shift the second image in offset 18 (e.g., by delaying the jetting time of the second image), and subsequently, controls the movement (e.g., reduces the speed) of blanket 44 to compensate for the offset, so that the first and second images are transferred, at the same position, to first and second sheets 50, respectively. One implementation technique of the compensation is described in detail in FIG. 3 below.

In the example of FIG. 2B, the deliberate offset (e.g., offset 18) between images produced, e.g., sequentially, in different revolutions of blanket 44, is carried out only along the X-axis. In other embodiments, processor 20 is configured specify any other suitable offset, which may be parallel or not parallel to moving direction 94. One example implementation of offsets not parallel to X-axis is described in detail in FIG. 2D below. Moreover, offset 18 may have any suitable size, also referred to herein as a step size, for example, between 1 μm and 10 mm.

In some embodiments that are also partially described above, the magnitude of the memory signature on blanket 44 is reduced by altering the position of the image produced on given panel 11 during different revolutions of blanket 44. In the example of FIGS. 2A and 2B, memory 16 of FIG. 2A appears in a black color (i.e., darker) than memories 16a-16c of FIG. 2B. The different gray-levels indicate that memory 16 has a stronger signature on the surface of blanket 44 compared to that of memories 16a-16c.

FIG. 2C is a schematic pictorial illustration of a deliberate offset applied to different copies of the image produced on the surface of different panels 11 of blanket 44, in accordance with another embodiment of the present invention.

In some embodiments, blanket 44 comprises panels 11a and 11b separated, along X-axis, by a section 13. Processor 20 may use marker 15, or any other suitable reference position, for controlling the position of a first image produced on panel 11a and a second image produced on panel 11b.

In the example of FIG. 2C, the first and second images are produced at first and second respective positions on the surface of panels 11a and 11b, respectively, and processor 20 controls the printing assembly to produce the second image at a shifted position relative to the position of the first image, as will be described in detail below. Subsequently, blanket 44 is moved by the printing assembly for transferring the first image to first sheet 50 and the second image to second sheet 50. Note that in the example of FIG. 2C and as opposed to the process described in FIGS. 2A and 2B, the first and second images are produced during the same revolution of blanket 44. After transferring the first and second images, undesired signatures of memories 23a and 23b are formed on the surface of panels 11a and 11b, respectively. Note that the position of memories 23a and 23b are indicative of the position of the first and second images described above.

In some embodiments, blanket 44 comprises lines 25a and 25b, indicative, respectively, of the left and right edges of panel 11a. Similarly, lines 25c and 25d are indicative, respectively, of the left and right edges of panel 11b. In the example of FIG. 2C, the edge of memory 23a appears to touch line 25a, whereas due to the shift applied to the position of the second image, memory 23b appears to be shifted along the X-axis, relative to line 25c, by an offset 24. The shifting direction of offset 24 is also referred to herein as a right direction (opposite to a left direction).

Based on the technique described in FIG. 2B above, processor 20 is configured to calculate the movement of blanket 44 that would compensate for offset 24 when transferring the image produced on panel 11b to a respective sheet 50. In some embodiments, processor 20 is configured to control the printing assembly to move blanket 44 in accordance with the calculated movement, for transferring the image produced on panel 11b to the respective sheet 50 without causing an image-to-substrate registration error or without affecting the magnitude thereof.

In some embodiments, blanket has eleven (11) panels (or any other suitable number of panels), and processor 20 is configured to apply the technique described in FIG. 2B above to each pair of images produced on a respective pair of adjacent panels 11. In the present example, processor 20 controls the printing assembly to shift the position of the image in panel 11b by offset 24, which is about 60 μm (or by another offset having any other suitable size and direction). Processor 20 may apply the same technique to each pair of images produced, respectively, on adjacent panels. For example, between the second image (of panel 11b) and a third image produced on a third panel (not shown) that is adjacent to and subsequent to panel 11b.

In such embodiments, the third image is shifted (to the right) relative to the left edge of the third panel (as well as relative to the position of the first image within the panel), by about 120 μm (obtained by applying two shifts of 60 μm between the first and third images). Moreover, after completion of the first revolution, the eleventh image, which is produced on the eleventh panel, is positioned at an offset of about 600 μm relative to the left edge of the eleventh panel, and also relative to the position (within each respective panel 11) of the first image.

Subsequently, the image produced in panel 11a during the second revolution, is positioned at an offset of about 660 μm (i.e., 11 shifts of about 60 μm) relative to the position of the first image produced on panel 11a during the first revolution. In other words, after transferring (to a respective sheet 50) the image produced on panel 11a during the second revolution, the memory signature of this image appears in panel 11a shifted by about 660 μm relative to the position of memory 23a. In other words, the step size, along X-axis, between adjacent images produced on the surface of each panel 11 during sequential revolutions of blanket 44, is about 660 μm.

In such embodiments, after transferring, to respective sheets 50, all the images produced during the second revolution of blanket 44, the offset between the first memory and second memory in every panel 11 of blanket 44, is about 660 μm. Similarly, after transferring, to respective sheets 50, all the images produced during the third revolution of blanket 44, the offset between the second memory and third memory in every panel 11 of blanket 44, is also about 660 μm.

In some embodiments, processor 20 is configured to define a stroke size, e.g., along X-axis, for the total amount of shifting the position of the images produced on panels 11 of blanket 44. In the example of FIGS. 2B and 2C, when applying a shift of an image, which is equal to offset 24 between adjacent panels, processor 20 may define a stroke size of about 60 mm along X-axis. In other words, after applying offset 24 to about 1,000 consecutive images produced, respectively, on the surface of 1,000 consecutive panels 11, processor 20 is configured to reverse the shifting direction. As described in FIG. 2B above, processor 20 may control the shifting direction by delaying or advancing the jetting of the ink droplets, relative to the originally intended jetting time. Moreover, using the technique described in FIG. 2B above, in addition to reversing the shifting direction, processor 20 is configured to: (a) calculate the movement of blanket 44 that would compensate for the reversed offset when transferring the image to the surface of the respective panel 11, and (b) control the printing assembly to move blanket 44 in accordance with the calculated movement, for transferring the image to the surface of the respective panel 11.

Note that the size of sheet 50 may alter based on the requirement of end customers of the printed product. In some embodiments, the limit of cumulative deliberate stroke size (e.g., about 60 mm as described above) depends on the size of sheet 50 in order to prevent an engagement between seam 45 and sheet 50 at impression station 84. In other words, a smaller size of sheet 50 along the X-axis, allows a cumulative deliberate stroke size larger than about 60 mm. For example, based on calculations and experimental data: (i) in case the size of sheet 50 along the X-axis is about 750 mm, the maximal allowed stroke size may be increased from about 60 mm to about 80 mm, (ii) in case the size of sheet 50 along the X-axis is about 700 mm, the maximal allowed stroke size may be increased to about 130 mm, and (iii) in case the size of sheet 50 along the X-axis is about 650 mm, the maximal allowed stroke size may be increased to about 180 mm.

In such embodiments, processor 20 is configured to control the printing assembly to retain the image shift of about 60 μm in each panel (e.g., offset 24), and to increase the number of shifts before reversing the shifting direction. In one of the examples described above, when the size of sheet 50 along the X-axis is about 650 mm, the maximal allowed stroke size is about 180 mm. In this example, processor 20 is configured to control the printing assembly to apply offset 24 to about 3,000 (instead of about 1,000 as described above) consecutive images that are produced, respectively, on the surface of about 3,000 consecutive panels 11. After applying offset 24 about 3,000, processor 20 is configured to reverse the shifting direction for applying offset 24 to about 3,000 consecutive images that are produced, respectively, on the surface of about 3,000 consecutive panels 11 in the reversed direction. In other words, the stroke size and number of consecutive images is increased by a factor of three.

In some embodiments, processor 20 is configured to control the shifting and direction reversing operation by applying a threshold to the stroke size (e.g., about 180 mm in the example described above), and/or to the number of images produced on respective panels (e.g., about 3,000 in the example described above) before reversing the direction of shifting.

In principle, it is possible to shift the image only every one or more revolution(s) of blanket 44, i.e., without shifting the image every panel. However, by applying small shifts (e.g., of about 60 μm) to every panel, which sum-up to a large offset (e.g., of about 660 μm) for each panel in each revolution, the memory effect on blanket 44 is reduced, and yet, image uniformity and the registration performance (e.g., C2C and image-to-substrate registration errors) of system 10 are not deteriorated.

FIG. 2D is a schematic pictorial illustration of deliberate offsets applied to respective copies of the image produced on the surface of a panel 11c of blanket 44, in accordance with another embodiment of the present invention.

As described in FIGS. 2B and 2C above, processor 20 controls the printing assembly to shift the position of the image along X-axis in a predefined offset, such as offset 18 of FIG. 2B above.

In the example embodiments shown in FIG. 2D, processor 20 is configured to control the printing assembly to shift the position of the images (e.g., copies of a given image) produced on the surface of panel 11c in any suitable direction other than parallel to X-axis, and in any suitable step size relative to the step size applied to a previous image produced on the surface of panel 11c during a former blanket revolution. For example, images 30 and 31 are produced during first and second respective revolutions of the surface of panel 11c of blanket 44.

In some embodiments, processor 20 controls the printing assembly to shift the position of image 31 in both X and Y axes relative to the position of image 30. More specifically, image 31 is shifted along the negative direction parallel to X-axis (i.e., opposite to the direction of the arrow of X-axis), and in the positive direction parallel to Y-axis. Subsequently, an image 32 is produced, e.g., in the next revolution of blanket 44, at a position that maintains the same shifting directions of image 31 relative to image 30, but using different step size in both X and Y axes.

In some embodiments, processor 20 controls the printing assembly to shift the position of image 33, relative to the position of image 32, along the negative direction parallel to both X and Y axes. The same shifting directions (but not necessarily the corresponding step sizes) are maintained in the positions of the next images produced in the next respective revolutions of blanket 44, including the position on an image 35.

In some embodiments, the shifting direction along Y-axis is reversed again when shifting the position of an image 36 relative to the position of image 35, and the same shifting directions are maintained until the production of an image 37 on panel 11c of blanket 44.

In some embodiments, processor 20 controls the printing assembly to shift the position of images 30-33 and 35-37 so as to obtain a shape of a wave 38 in the shifted positions of images produced on panel 11c during respective revolutions of blanket 44.

In some embodiments, processor 20 controls the printing assembly to repeat the shifting of the position of the images produced on panel 11c, so as to repeat the shape of wave 38 along the panel, and subsequently, to retain or alter the shape of wave 38 when reversing the shifting direction in X-axis. Note that wave 38 may have a regular shape or a non-regular shape.

In other embodiments, instead of producing the images in accordance with the shape of wave 38, processor 20 is configured to control the printing assembly to shift the positions of the images produced in every revolution of blanket 44, in accordance with any other regular pattern (e.g., a spiral) or a non-regular pattern.

FIG. 3 is a schematic side view of an apparatus for compensating an offset in a position of an image produced on blanket 44 when transferring an image to sheet, in accordance with an embodiment of the present invention.

In the example of FIG. 3, the apparatus comprises, inter-alia, BCD 77, BTD 99 and impression station 84 of FIG. 1 above, which are controlled by processor 20 to compensate for multiple offsets, such as offset 24, shown and described in detail in FIG. 2C above. Note that the techniques described in FIG. 3 below, are also applicable, mutatis mutandis, to compensate for offset 18 shown in FIG. 2B above or to any other offset and/or shifting of the present disclosure.

As described in FIG. 1 above, processor 20 is configured to control BCD 77 and BTD 99 to move blanket at a preassigned speed in direction 94. The term preassigned indicates that the speed of blanket 44 is not predefined to a constant value, but is adjusted in order to compensate for the offsets described above. Blanket 44 is moved between BTD 99 and BCD 77 for producing images on a surface 44a of panels 11. Subsequently, blanket 44 is moved from BCD 77 to impression station 84 for transferring the image produced on each panel 11 to a respective sheet 50, and after transferring the image, blanket 44 is moved between impression station 84 and BTD 99 for starting the next revolution as described in FIGS. 2A-2C above.

Reference is now made to pressure cylinder (PC) 90, which is rotated clockwise. In some embodiments, a compressible blanket (CB) 19 is placed in contact with the circumference of PC 90 and is coupled to walls 41 of a gap 43 of PC 90, so as to remain taut on the circumference of PC 90.

In some embodiments, gap 43 is facing blanket 44 only when section 13 is moved between PC 90 and impression cylinder (IC) 82, as shown in FIG. 3. Note that in this position, sheet 50 is not fed between PC 90 and IC 82. Note that in the present example, gap 43 has an area that is about fifth of the total area of PC 90.

In some embodiments, when panel 11 and sheet 50 are moved between PC 90 and IC 82, CB 19 that is in contact with the circumference of PC 90, is configured to press blanket 44 against sheet 50, so as to transfer the image from surface 44a to sheet 50.

Reference is now made to IC 82, which is rotated counterclockwise and in the present example, has a double diameter relative to the diameter of PC 90.

In some embodiments, IC 82 has two open angles 47, each of which comprises a gripper 49 configured to grip and to move sheet 50 between PC 90 and IC 82 for transferring the image from surface 44a of panel 11 to sheet 50, as described above.

In some embodiments, sections 51 and 53 on the circumference of IC 82 are configured to press sheet 50 against blanket 44, so as to receive the image from surface 44a of panel 11. Note that during the image transfer, a first sheet 50 fits over section 51, and after transferring the image, the first sheet 50 is moved by substrate transport module 80 toward output stack 88. Moreover, in the present example, during the operation of impression station 84, gap 43 and open angle 47 are typically facing one another, and at the same time, section 13 of blanket 44 passes between PC 90 and IC 82 when blanket 44 is moved in direction 94. Subsequently, a second sheet 50 (not shown) is gripped and moved by gripper 49 of the other (e.g., opposite) open angle 47, so as to fit over section 53, for transferring the next image from the next panel 11 to the second sheet 50. The operation of impression station 84 and the components thereof are described in more detail, for example, in PCT international publication number WO 2020/099976A1 to Lean et al., whose disclosure is incorporated herein by reference.

Reference is now made to the general view of FIG. 3. As described in FIGS. 2B and 2C above, processor 20 is configured to calculate the movement of blanket 44 that would typically compensate for the offset when transferring the shifted image to a respective sheet 50.

In some embodiments, processor 20 controls BCD 77 and BTD 99 to adjust the speed of blanket 44 in accordance with the calculated movement, for transferring the shifted image to the respective sheet 50 without causing an image-to-substrate registration error.

FIG. 3 depicts one possible implementation of the offset compensation. In some embodiments, processor 20 is configured to define, e.g., between dashed lines 46a and 46b, a stroke 39, which is indicative of the total amount of shifting the position of the images produced on panels 11 of blanket 44. In accordance with the example embodiments of FIGS. 2B, 2C and optionally 2D, processor 20 may define the size of stroke 39 to be about 60 mm along X-axis.

In the example of FIG. 3, the adjusted speed of blanket 44 relative to the blanket's nominal speed is marked using arrows 48a and 48b, wherein arrow 48a represents a higher speed of blanket 44 relative to the nominal speed, and arrow 48b represents a lower speed of blanket 44 relative to the nominal speed.

As shown and described in FIG. 2C above, the second image is shifted to the right along the X-axis, so as to have memory 23b appears at offset 24 relative to line 25c. In other words, the position of memory 23b is behind its nominal position by the amount of offset 24 (e.g., by about 60 μm), relative to moving direction 94. In some embodiments, processor 20 controls BCD 77 and BTD 99 to increase the speed of blanket 44 to a speed higher than the aforementioned nominal speed, so as to compensate for offset 24, and thereby transfer the image to the same position on all sheets 50.

In other words, when the position on an image is shifted to be behind its nominal position, processor 20 adjusts the speed of blanket 44 to exceed the nominal speed, so as to compensate for the shifted position of the image produced by image forming station 60 on surface 44a of blanket 44. These embodiments are illustrated in FIG. 3.

In an embodiment, in response to applying offset 24, seam 45 of blanket 44 is moved in a relative speed in a direction 48a, i.e., in a speed higher than the nominal speed of blanket 44. In another embodiment, in response to applying an offset in a direction opposite to the direction offset 24, seam 45 is moved in a relative speed in a direction 48b, i.e., in a speed lower compared to the nominal speed of blanket 44. Note that in the example of FIG. 3, blanket 44 is always moved in direction 94, but arrows 48a and 48b are indicative of the relative speed of blanket 44 compared to the nominal speed thereof.

In some embodiments, in accordance with the embodiments described in FIG. 2C above, processor 20 controls BCD 77 and BTD 99 to adjust the speed of blanket 44, so as to compensate for the 60 μm offset in every panel 11 of blanket 44. Note that, when gap 43 and open angle 47 are facing one another, and seam 45 is moved between PC 90 and IC 82, processor 20 controls the position of seam 45 to be within the range of stroke 39, i.e., between dashed lines 46a and 46b.

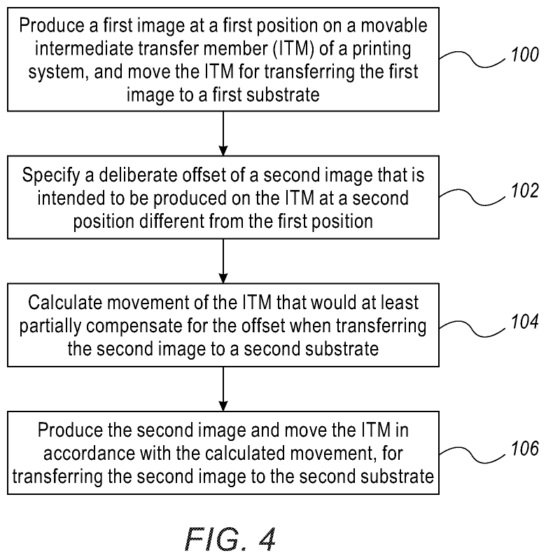

FIG. 4 is a flow chart that schematically illustrates a method for reducing the appearance of the memory effect in blanket 44, in accordance with an embodiment of the present invention.

The method begins at a first image printing step 100, with processor 20 controlling the printing assembly to produce a first image at a first position, such as the position of memory 16a on panel 11 of blanket 44 (shown in FIG. 2B above), and subsequently, to move blanket 44 in direction 94 for transferring the first image from panel 11 to a first sheet 50, as described in detail in FIGS. 1 and 2B below.

At an offset specification step 102, processor 20 specifies offset 18 of a second image that is intended to be produced on panel 11 of blanket 44, at a second position. In the example of FIG. 2B, the second position comprises the position of memory 16b, which is different from the first position, e.g., the position of memory 16a, as described in detail in FIG. 2B above.

At a compensation calculation step 104, processor 20 calculates the movement of blanket 44 that would, at least partially and typically fully, compensate for offset 18 when transferring the second image to a second sheet 50, as described in detail in FIG. 2B above.

At a second image printing step 106, processor 20 controls the printing assembly to produce the second image, and to move blanket 44 in accordance with the calculated movement, for transferring the second image to the second sheet 50, as described in detail in FIG. 2B above.

In some embodiments, the first and second images are copies of a given image, and the position of memory 16b (indicative of the position of the second image), partially overlaps the position of memory 16a (indicative of the position of the first image).

As described in FIG. 1 above, blanket 44 has a shape of a continuous blanket loop, and rotates in multiple revolutions. In some embodiments, during a first revolution of blanket 44, processor 20 controls the printing assembly to produce the first image by positioning blanket 44 at the first position relative to image forming station 60. During a second revolution of blanket 44, processor 20 controls the printing assembly to produce the second image by positioning blanket 44 at the second position relative to the image forming station, as described in detail in FIG. 2B above.

In some embodiments, as shown and described in detail in FIG. 2C above, after producing the first image (e.g., during the first revolution of blanket 44) and before producing the second image (e.g., during the second revolution of blanket 44), processor 20 controls the printing assembly to produce on blanket 44 a third image at a third position. In the example of FIG. 2C above, memory 23a is indicative of the position of the first image, and memory 23b is indicative of the position of the third image, which is shifted relative to an intended position thereof (e.g., by offset 24). Processor 20 is further configured to calculate the movement of blanket 44 that would compensate for offset 24 when transferring the third image to a third sheet 50. Processor 50 controls the printing assembly to move blanket 44 in accordance with the calculated movement, for transferring the third image to the third sheet 50.

In some embodiments, the deliberate offset (e.g., offset 18 or offset 24) is specified along X-axis, which is parallel to moving direction 94, as shown and described in detail in FIGS. 2B and 2C above.

In alternative embodiments, the deliberate offset is specified at any direction or at a combination of movement along X and Y axes, and a step size that may be constant or altered, as described in detail in FIG. 2D below.

Although the embodiments described herein mainly address digital printing using a flexible intermediate transfer member, the methods and systems described herein can also be used in other applications, such as in any sort of printing system and process having any suitable type of an intermediate apparatus (e.g., member) for receiving an image and transferring the image to a target substrate.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for printing, the method comprising:
producing a first image at a first position on a movable intermediate transfer member (ITM) of a printing system, and moving the ITM for transferring the first image to a first substrate; and
for a second image that is intended to be produced on the ITM at a second position different from the first position:
specifying a deliberate offset of the second position relative to the first position;
calculating a movement of the ITM that would at least partially compensate for the offset when transferring the second image to a second substrate; and
producing the second image and moving the ITM in accordance with the calculated movement, for transferring the second image to the second substrate.

2. The method according to claim 1, wherein the first and second images are copies of a given image.

3. The method according to claim 1, wherein the second position, which is covered by the second image, partially overlaps the first position, which is covered by the first image.

4. The method according to claim 1, wherein the ITM comprises a closed loop, which is rotated, and wherein: (i) during a first revolution of the ITM, producing the first image by positioning the ITM at the first position relative to an image forming station, and (ii) during a second revolution of the ITM, producing the second image by positioning the ITM at the second position relative to the image forming station.

5. The method according to claim 4, and comprising after producing the first image and before producing the second image: (i) producing on the ITM a third image at a third position, which is shifted relative to an intended position of the third image, (ii) calculating an additional movement of the ITM that would at least partially compensate for the shifting when transferring the third image to a third substrate, and (iii) moving the ITM in accordance with the calculated additional movement, for transferring the third image to the third substrate.

6. The method according to claim 1, wherein the deliberate offset is specified at a direction parallel to a moving direction of the ITM.

7. The method according to claim 1,
wherein the deliberate offset is specified at a direction that is not parallel to a moving direction of the ITM.

8. The method according to claim 1, wherein the deliberate offset of the second position is carried out along a first direction, and comprising, for a plurality of third images intended to be produced on the ITM at a plurality of third positions, respectively, different from the first and second positions: (i) specifying additional deliberate offsets of the third positions along the first direction based on a predefined stroke size, (ii) calculating a plurality of third movements of the ITM that would at least partially compensate for the additional deliberate offsets when transferring the third images to third substrates, respectively, and (iii) producing the third images and moving the ITM in accordance with the calculated movement, for transferring the third images to the third substrates, respectively.

9. The method according to claim 8, wherein the first, second and third substrates have a given size at least along the first direction, and wherein at least the predefined stroke size depends on the given size.

10. The method according to claim 8, and comprising, after applying the deliberate offset and the additional deliberate offsets and producing and transferring the first, second and third images in accordance with the predefined stroke size, performing the deliberate offset and the additional deliberate offsets at a second direction, different from the first direction.

11. A system, comprising:
a printing assembly, which is configured to: (i) produce a first image at a first position on a movable intermediate transfer member (ITM) of a printing system, and to move the ITM for transferring the first image to a first substrate, and (ii) produce a second image at a second position, different from the first position, and to move the ITM for transferring the second image to a second substrate; and
a processor, which is configured to: (i) specify a deliberate offset of the second position relative to the first position, (ii) calculate a movement of the ITM that would at least partially compensate for the offset when transferring the second image to the second substrate, and (iii) control the printing assembly to move the ITM in accordance with the calculated movement, for transferring the second image to the second substrate.

12. The system according to claim 11, wherein the first and second images are copies of a given image.

13. The system according to claim 11, wherein the processor is configured to specify the deliberate offset of the second position, which is covered by the second image, to partially overlap the first position, which is covered by the first image.

14. The system according to claim 11, wherein the ITM comprises a closed loop, which is rotated, and wherein: (i) during a first revolution of the ITM, the processor is configured to control the printing assembly to produce the first image by positioning the ITM at the first position relative to an image forming station, and (ii) during a second revolution of the ITM, the processor is configured to control the printing assembly to produce the second image by positioning the ITM at the second position relative to the image forming station.

15. The system according to claim 14, and comprising after producing the first image and before producing the second image, the processor is configured to control the printing assembly to: (i) produce, on the ITM, a third image at a third position, which is shifted relative to an intended position of the third image, (ii) calculate an additional movement of the ITM that would at least partially compensate for the shifting when transferring the third image to a third substrate, and (iii) move the ITM in accordance with the calculated additional movement, for transferring the third image to the third substrate.

16. The system according to claim 11, wherein the processor is configured to specify the deliberate offset at a direction parallel to a moving direction of the ITM.

17. The system according to claim 11, wherein the processor is configured to specify the deliberate offset at a direction that is not parallel to a moving direction of the ITM.

18. The system according to claim 11, wherein the processor is configured to specify the deliberate offset of the second position along a first direction, and comprising, for a plurality of third images intended to be produced on the ITM at a plurality of third positions, respectively, different from the first and second positions, the processor is configured to: (i) specify additional deliberate offsets of the third positions along the first direction based on a predefined stroke size, (ii) calculate a plurality of third movements of the ITM that would at least partially compensate for the additional deliberate offsets when transferring the third images to third substrates, respectively, and (iii) produce the third images and move the ITM in accordance with the calculated movement, for transferring the third images to the third substrates, respectively.

19. The system according to claim 18, wherein the first, second and third substrates have a given size at least along the first direction, and wherein at least the predefined stroke size depends on the given size.

20. The system according to claim 18, and comprising, after applying the deliberate offset and the additional deliberate offsets and producing and transferring the first, second and third images in accordance with the predefined stroke size, the processor is configured to perform the deliberate offset and the additional deliberate offsets at a second direction, different from the first direction.
